(19) United States
(12) Patent Application Publication
(10) Pub. No.: US 2019/0298045 A1
(43) Pub. Date: Oct. 3, 2019

(54) UNIVERSAL RETAINING DEVICE FOR EYE WEAR AND SMALL TOOLS

(71) Applicant: Jack Strelioff, Woodland Hills, CA (US)

(72) Inventor: Jack Strelioff, Woodland Hills, CA (US)

(21) Appl. No.: 16/366,891

(22) Filed: Mar. 27, 2019

Related U.S. Application Data
(60) Provisional application No. 62/649,665, filed on Mar. 29, 2018.

(51) Int. Cl. A45F 5/02; F16M 13/04

(52) U.S. Cl. CPC A45F 5/02; G02C 11/00; F16M 13/04

(57) ABSTRACT

The present invention comprises a novel retaining device for eye wear and other frequently used small tools or items for holding these securely in pockets, etc. This retaining device consists of a “U” shaped spring clamping member which is installed onto the piece to be retained using a number of binding sleeve type options. Specific types of elastic sleeves, heat shrink tubing and engineered adhesive tape strips would allow a retaining device to be attached onto a range of shapes and sizes of devices. The retaining device can be visually and physically unobtrusive, so as not to distract from the design intent of the eye wear stylist or it can compliment the styling. Conversely, the retaining device may be color coded for easily identifying tools or display advertising motif when used on eyewear, tools and other instruments.

### FIELD OF THE INVENTION

The present invention relates to a novel retaining device for items such as eyeglasses and many other small hand instruments or tools used frequently on a daily basis. More particularly, this invention offers an economical device allowing for several unique and simple installation procedures onto various sizes and shapes of such items.

### BACKGROUND

Eyeglasses, sunglasses, as well as other small hand instruments, such as rules or scales, screw drivers, files, small wrenches and the like, are often inadvertently left forgotten, misplaced, dropped and damaged during daily usage. Presently, there is no single, easily installed retaining device which allows Users to secure and safely retain a varied and wide selection of these items.

Currently, there is no universal, non-altering, removable retaining device for eye wear and sunglasses. Cases for eye wear and sunglass can have “pocket clips” but these cases are mostly visually unappealing, bulky and often allow eyewear to simply fall out if the User bends down. Cases, which are designed to be worn with a User's belt are cumbersome and afford little protection for the eye wear or other devices as these protrude and thus are prone to be often bumped, resulting in damage to the contents.

Presently, there are some retaining devices or “pocket clips”, as these are often called, mostly for pens and pencils; and a few small hand instruments such as tire pressure gauges and sometimes on small screwdrivers. However, these clips are always item specific by shape and sizing, often permanently attached and thus limited for use to the unique device on which they are found.

Therefore, a need exists among eye wear and/or small devices Users, for a novel retaining device. A further need exists for a retaining device to conform to and be compatible with a wide range of tool sizes, shapes and configurations. Finally, there is a need for this retaining device to be provided with simple installation procedure(s) and be inexpensive so as to be available to a wide range of Users having diverse requirements.

### BRIEF SUMMARY OF THE INVENTION

The present invention comprises a novel retaining device for eye wear and other frequently used small tools. This retaining device consists of a “U” shaped spring member which is installed onto the piece to be retained using highly compliant elastic sleeving. The elastic sleeving allows the “U” spring member to be placed and solidly positioned exactly where necessary onto a wide range of shapes and sizes of devices due to its ability to expand over features and then tightly bond onto member surfaces. The retaining device can be discrete, thus visually and physically unobtrusive so as not to distract from the design intent of the eye wear stylist. Conversely, the retaining device may be color coded or have advertising motif when used on tools and other instruments.

### BRIEF DESCRIPTION OF THE DRAWINGS

Some embodiments of the present invention are illustrated as an example and are not limited by the figures of the accompanying drawings, in which like references may indicate similar elements and in which:

FIG. 1-FIG. 1A depicts a perspective view of the basic components comprising the invention.

FIG. 1-FIG. 1B illustrates a perspective view of the Steps S1 through S5 for the installation of the retaining device onto typical eyeglasses.

FIG. 2-FIG. 2A and Detail depict with perspective views the retaining device installed on a style of eyeglasses with a very thick molded frame.

FIG. 2-FIG. 2B and Detail depict with perspective views the retaining device installed on a style of eyeglasses with a very thin wire frame.

FIG. 3-FIGS. 3A and 3B depict with perspective views the retaining device installed on instruments of varying sizes and shapes for adaptation to use on shirt pockets as well as other locations.

FIG. 4-FIGS. 4A, 4B, 4C and 4D depict with perspective views the basic retaining device and improvements to broaden User and marketing opportunities.

FIG. 5-FIGS. 5A and 5B depict with perspective views the most practical types of binding sleeves for attaching the retaining device to eyeglasses or tools.

FIG. 6-FIGS. 6A, 6B and 6C depict with perspective views several methods to size the elastic sleeve for attaching a retaining device to eyeglasses or tools.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising” when used in this specification, specify the presence of stated features, steps, operations, elements, and/or components, but do not preclude the presence or addition of one or more other features, steps, operations, elements, components, and/or groups thereof.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and claims.

A novel multipurpose retaining device and the unique method for installing and positioning for use with eyeglasses as well as many other small instruments or tools are discussed herein. In the following description, for the purposes of explanation, numerous specific details are set forth in order to provide thorough understanding of the present invention.

The present disclosure is to be considered as an exemplification of the invention, and is not intended to limit the invention to the specific embodiments illustrated by the figures or description below.

Although only three (3) basic components, including for installation thereof, comprise the elements of this invention, it is important to credit that it is the interdependence of each of these components which create the unique property, effectiveness and usefulness of the invention described herein.

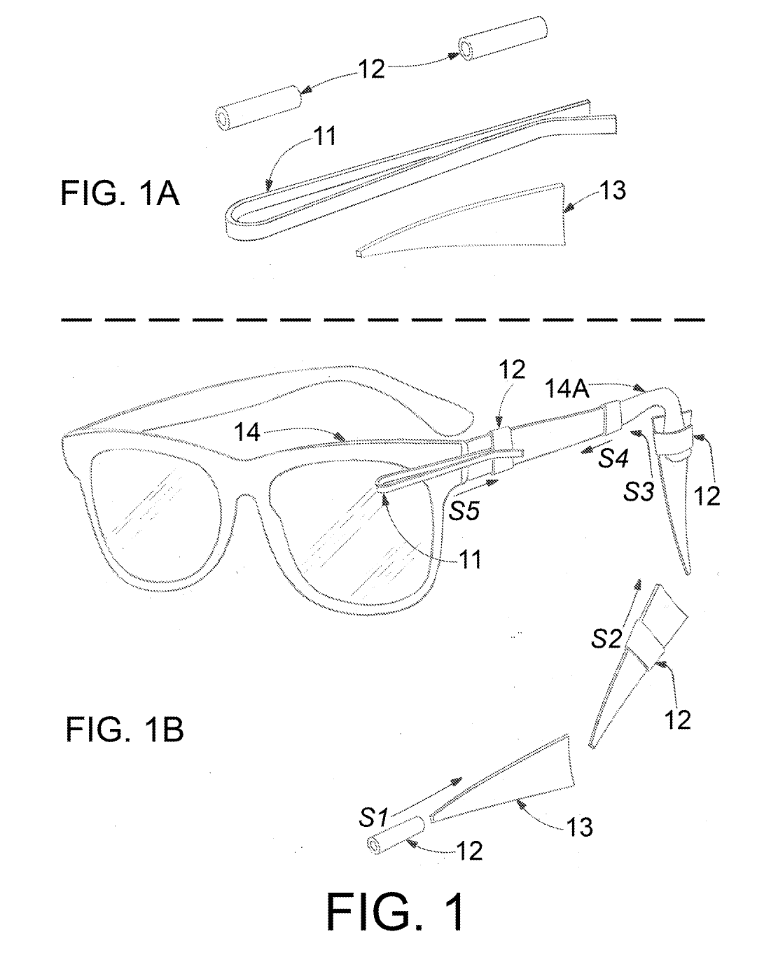

The present invention will now be described by referencing the appended figures representing preferred embodiments. FIG. 1A depicts an exploded perspective view of the elements that may comprise a universal retaining device (the “device”) according to various embodiments of the present invention, as applied to use with a pair of eyeglasses (or sunglasses) and other tools or instruments as a User convenience.

FIG. 1-FIG. 1A illustrates the most basic form of the actual retaining device, Part 11, as a “U” shaped piece having a strong tendency to maintain and/or return to this given shape even after thousands of flexings during its prescribed usage. The thickness, width, length and other dimensional characteristics may vary according to the application requirements and material selected for making the retaining device.

In this discussion for the patent application, the retaining device material employed for the purposes of prototyping and demonstrating functionality, is a medium grade ferrous strip which is suitable for simple stamping, machining and/or cold forming processes for manufacture.

Materials and processes which could also be used for the manufacture of this “U” shaped member include, but are not limited to the following: molded plastics; extruded plastics; extruded aluminum or other non-ferrous metals where magnetic interference may be a consideration, woods and other suitable materials.

FIG. 1-FIG. 1A illustrates the most basic form of the actual retaining device binding sleeve, Parts 12, as lengths of latex rubber tubing, although other types of elastic tubing may function equally well. The elastic sleeving features substantial compliance, allowing the User to expand and maneuver these onto eye wear frames and small tools handles with the “U” retainer installed between. Once aligned into place, the elastic sleeve resumes minimum form. thus securely binding the retaining device to the host item (eyeglasses or tool/instrument).

Within the discussion for patent application, the retaining device is illustrated as bonded to the host eyeglasses or other small tool using two elastic binding sleeves. However, in some other embodiments, the retaining device of the present invention may comprise only one, two (as shown) or three and more elastic binding sleeves, as necessary for best functional and/or visual style options as decided by the User.

Alternative materials, other than the elastic binding sleeves, Part 12, may be used for installing the retaining device, Part 11, and these are discussed within Paragraph [0039] of this document.

FIG. 1-FIG. 1A depicts the basic form of the sizing tool, Part 13, which is employed to expand the elastic binding sleeve, Part 12, and maneuver this onto an eyeglasses frame and/or small tools handle. The sizing tool measures about 2.5 inches in length and employs about a 15 degree angle for easily and effectively expanding the elastic binding sleeves, Part 12, and especially when a drop of liquid soap is added to lubricate the sliding motion of the sleeve. The “V” shaped sizing tool should be slightly flexible, about 0.050 inch thick and may be made from Polytetrafluoroethylene (PTFE), Polyoxymethylene (POM), Ultra High Molecular Weight polyethylene, or other plastics; or other machined or molded materials which will exhibit suitable low friction surfaces.

FIG. 1-FIG. 1B illustrates a perspective view of the Steps S1 through S5 for the installation of the retaining device onto eyeglasses, Part 14. Step S1 aligns the elastic sleeve, Part 12, with the narrow end of the sizing tool, Part 13, and at this time a small amount of liquid soap on the sizing tool is recommended for lubrication purposes. Step S2 moves to expand the elastic sleeve, Part 12. Step S3 transfers the elastic sleeve from the sizing tool, Part 13, onto the eyeglasses ear cushion of the temple arm, part 14A. Step S4 moves the elastic sleeve into position. Step S5 places the “U” shaped retaining device, Part 11, beneath both elastic sleeves to be held in place, with the forward sleeve having been previously installed by this same process.

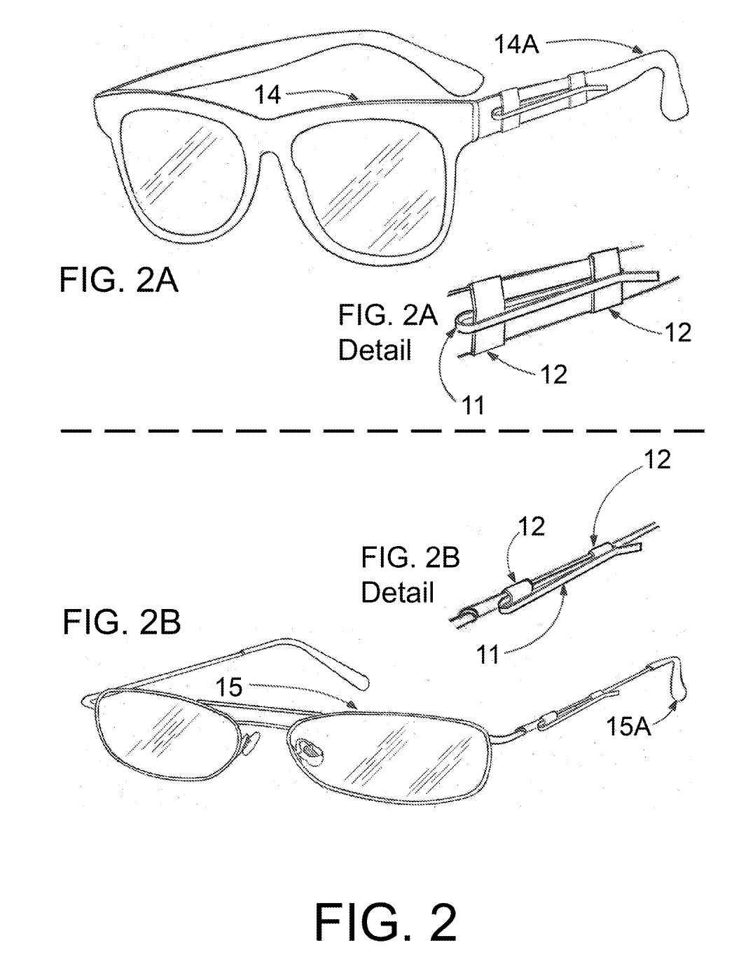

FIG. 2-FIG. 2A and FIG. 2B illustrate the range of applications whereby the retaining device can be bonded with equal effectiveness to eyeglasses with frames with very different dimensional characteristics. The highly elastic property of the binding sleeve to contract to its original extruded dimensions cause a tight bond of the retaining device to the eye wear frames. In addition, the frictional characteristics of the elastic sleeve keep these pieces secured in the position as originally installed.

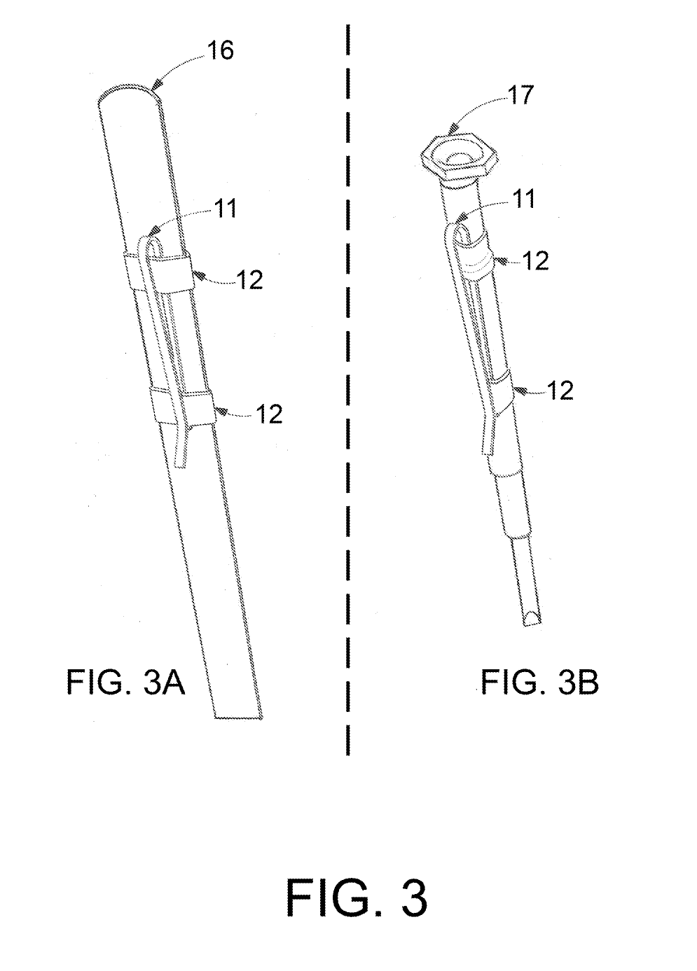

FIG. 3-FIG. 3A and FIG. 3B illustrate the range of applications whereby the retaining device can be bonded with equal effectiveness to small instruments and hand tools having very different dimensional characteristics. The highly elastic property of the binding sleeve to contract to its original extruded dimensions cause a tight bond of the retaining device to the different tools. As well, the frictional characteristics of the elastic keep these pieces secured as originally installed. FIG. 3-FIG. 3A depicts a clear version of the elastic sleeve used on the precision metal scale/rule so as not to obstruct the nomenclature from being viewed.

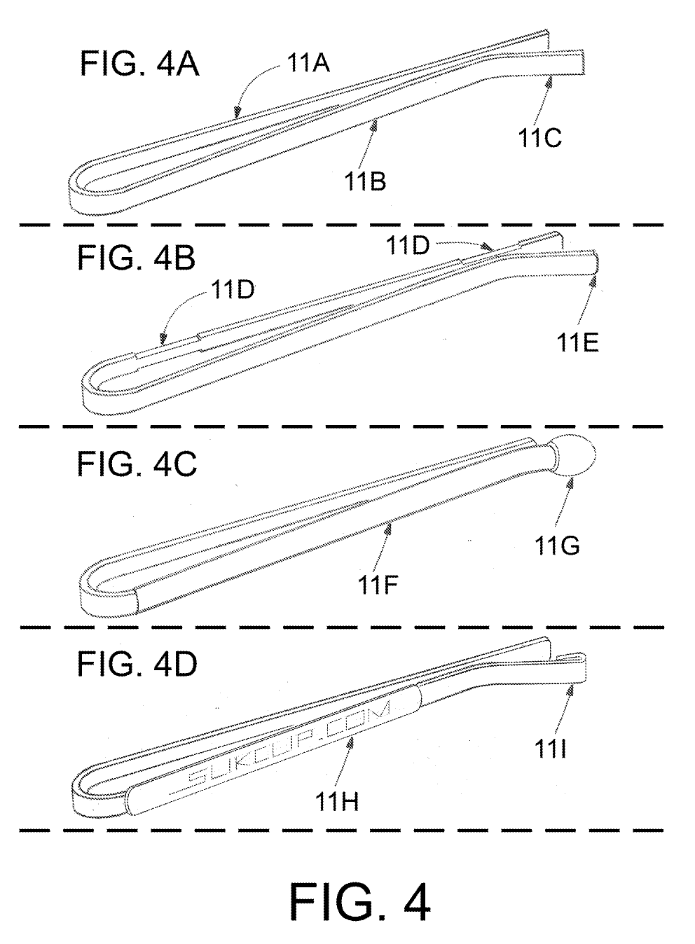

FIG. 4-FIGS. 4A, 4B, 4C and 4D depict with perspective views the basic retaining device and improvements to broaden User and marketing opportunities.

FIG. 4-FIG. 4A depicts the basic retaining device as discussed previously in paragraphs [0022], [0023], [0024]. Part 11, 11A, shows the member of the retaining device to be placed adjacent to the eyeglasses, small hand tool or instrument. Part 11, 11B shows the flexing member of the retaining device. Part 11, 11C shows the outward bent tang to facilitate affixing the retaining device in a pocket or other location.

FIG. 4-FIG. 4B depicts a basic retaining device, Part 11, with positioning notches, 11D, added to possibly provide more secure positioning, and 11E, the rounding of the tang for preventing damage to pocket fabric and the like.

FIG. 4-FIG. 4C depicts a basic retaining device, Part 11, with a finishing added, 11F, which may be comprised of plating, paint, sheathing or other treatments to enhance or coordinate the device aesthetically with eye wear upon which it is installed. The added bead piece, 11G, also can serve aesthetically, as well as providing easier manipulation of the retaining device for placing or removing from shirt pockets and the like.

FIG. 4-FIG. 4D illustrates a basic retaining device with panel, 11H, added for branding and promoting the eye wear pieces, small tools or instruments upon which it is attached and other promotional purposes. Promotional logos and branding can also be stamped or otherwise affixed to the retaining device. Feature 11I shows a finish bend.

FIG. 4-FIGS. 4B, 4C, 4D illustrate only some of the improvements and possible variations from the basic retaining device and do not limit the embodiments to only the examples shown and/or discussed herein.

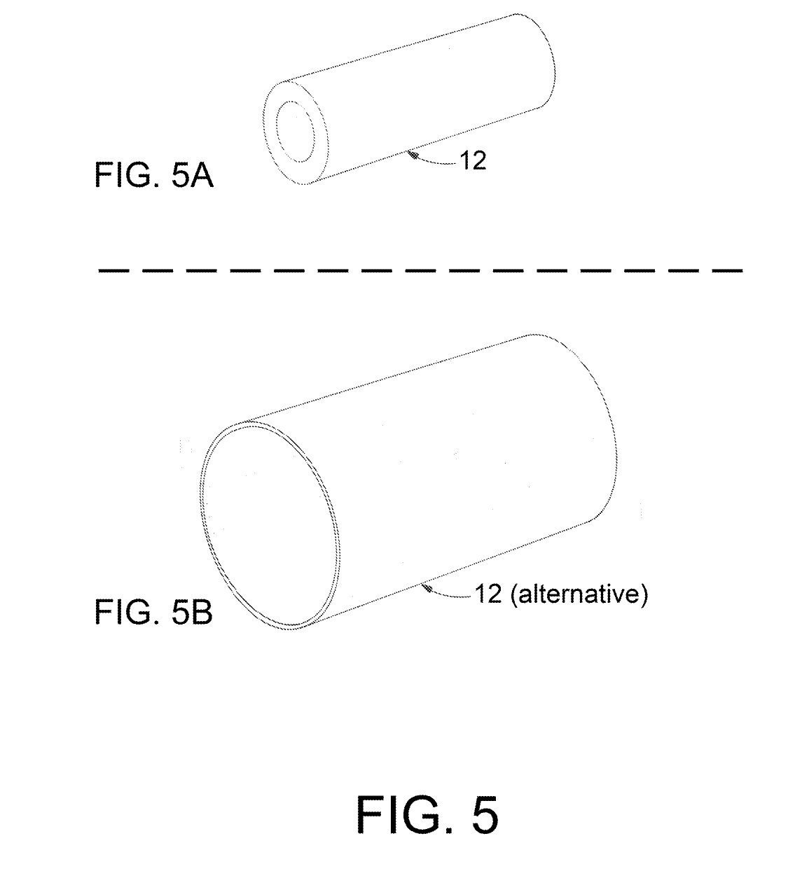

FIG. 5-FIG. 5A illustrates the elastic binding sleeve, Part 12, in the basic form. These may be derived, in various internal diameters and wall dimensions, from extruded surgical grade latex rubber tubing and cut to specific lengths, depending on the requirements for specific applications. The elastic binding sleeves could also be molded individually from the same or another material having the same performance qualities. The commonly available colors for extruded latex tubing are natural (amber) and black. An important advantage of the elastic binding sleeve is that it can be easily installed and as easily removed without any degrading, discoloration or damage to the host item.

FIG. 5-FIG. 5B depicts a length of heat shrink tubing, Part 12 (alternative) as a second material and method of installation as a binding sleeve. Heat shrink tubing will work well for applications which have the retaining device mounted to items not affected by a moderate amount of heat applied for a short time by a heat gun (items such as all-metal eye wear frames, small hand tools and instruments). Heat shrink tubing is available in a wide range of dimensions and colors, thus particularly useful in applications for mounting the retaining device to small hand tools and instruments.

Although not illustrated, there are a number of types of adhesive tapes which may be substituted as an alternative binding sleeve. Tapes are also available in many colors, widths and performance characteristics. Specially engineered tapes may also demonstrate qualities of latex tubing or heat shrink tubing. These adhesive tapes must have resilient qualities and not be adversely affected by heat and humidity.

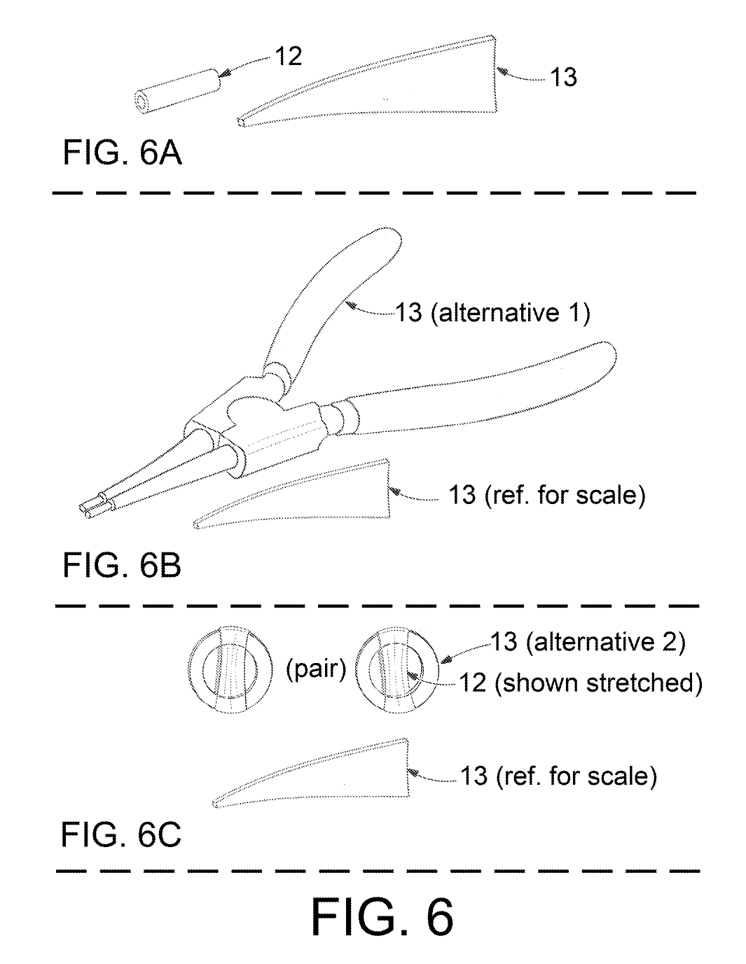

FIG. 6-FIG. 6A depicts the sizing tool, Part 13, at approximately actual size (about 2.5 inches long) for reference purposes. The sizing tool, as designed, is an important consideration for the patent, since it facilitates the installation of the retaining device with no other tools required. The sizing tool is also economical to manufacture and requires minimum space where the retaining device is packaged for display and marketing for the User at retail, thus providing for maximum value.

FIG. 6-FIG. 6B illustrates a sizing tool with a commonly available “O” ring installation tool. The “O” ring installer tool, or like device, would serve as a convenient way for a salesperson to apply the binding sleeves more quickly for customers in a retail environment. This hand tool would be included as part of a bulk components kit for the retaining device provided to retailers specializing in the sale of eye wear, as well as retailers for small specialty hand tools and instruments.

FIG. 6-FIG. 6C shows expanded binding sleeves mounted on “O” form sleeve carriers as an alternative to the “V” shaped sizing tool. As shown, a number of the elastic sleeves are pre-stretched and held on “O” shaped plastic forms or washers. The expanded elastic binders can be easily installed onto most eye wear temple arms, small tools or instruments and positioned for insertion of the “U” retainer. The washers are then removed to allow the elastic sleeves to contract and hold the retaining clip in place. As with using the “V” shaped sizing tool. a drop of liquid soap applied during the installation process will reduce most of the friction during the positioning of the retaining device components. Although the sleeve carrier is illustrated herein as a circular shape, it may employ different but equally effective forms. These “O” assemblies may replace the “V” shaped sizing tool and loose elastic sleeves in a retaining device installation “kit” or be added to such a packaged kit as a convenient alternative.

While preferred materials for elements have been described, the device is not limited by these materials. Many other materials may comprise some or all of the elements of the retaining device in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A retaining device for eyeglasses, sunglasses, small instruments and hand tools to secure these items in pockets, purses, briefcases and the like comprising:
a. a “U” shaped retainer;
b. an elastic binding sleeve to mount the retainer to item to be retained;
c. a “V” shaped sizing tool to open the elastic binding sleeves during the installation; or alternately, an “O” shaped form assembly having a prior expanded elastic sleeve mounted and prepared for installation onto the item to be retained.

2. The retaining device of claim 1 further comprising the alternative use of heat shrink tube binding sleeves or flexible adhesive tape binding strips to mount the retainer to the item to be retained in circumstances wherein the use of these may be preferred or more effective for the installation or use thereof.
